(19) United States
(12) Patent Application Publication
(10) Pub. No.: US 2009/0242117 A1
(43) Pub. Date: Oct. 1, 2009

(54) Bead positioning tool

(76) Inventor: Nikhil Gupta, Schaumburg, IL (US)

Correspondence Address: Olson & Cepuritis, LTD., 20 NORTH WACKER DRIVE, 36TH FLOOR, CHICAGO, IL, 60606, US

(21) Appl. No.: 12/383,513

(22) Filed: Mar. 25, 2009

Related U.S. Application Data
(60) Provisional application No. 61/070,718, filed on Mar. 25, 2008.

(51) Int. Cl. B32B 37/00

(52) U.S. Cl. 156/297; 156/539

(57) ABSTRACT

The present invention is directed towards a bead positioning device comprising two tools used position small embellishments onto jewelry, scrapbooks, containers and clothing. Each tool has an adhesive member and a positioning member. The positioning member comprises a plurality of prongs. In use, the embellishment is secured to the adhesive member of the first tool. Once secured, the positioning member of the second tool is used to remove the embellishment from the first tool and position the embellishment onto the desired location.

### CROSS-REFERENCE TO RELATED APPLICATION

This application claims the priority of Provisional Patent Application Ser. No. 61/070,718 filed on Mar. 25, 2008 which is incorporated herein by reference.

### FIELD OF THE INVENTION

The present invention relates generally to tools for making jewelry. In particular, the present invention relates to tools for positioning beads, stones or other embellishments during jewelry making and craft projects.

### BACKGROUND OF THE INVENTION

Decorative embellishments such as beads, jewels, rhinestones, flat backs, stickers or other small objects are frequently used in the art of jewelry making, scrapbooking and other crafts. For decorative purposes, these embellishments are adhered to the desired medium. In order to form aesthetically pleasing patterns, these embellishments must be carefully and precisely positioned.

This task is made difficult by the nature of the embellishments. Small and irregularly shaped embellishments are difficult to pick up and manipulate with fingers. Due to the size of the embellishments and the intricate designs that they are a part of, it is also difficult to position them precisely in the desired location and orientation on the medium. Once the task of positioning embellishments is accomplished, attempts to apply pressure to set the embellishments into the adhesive on the medium results in adhesive on fingers and undesirable movement of the embellishments on the medium.

There is a need for a convenient tool that can facilitate the action of picking up and positioning embellishments. It is important that this tool permit the user to easily pick up single embellishments for positioning. The user should also be able to easily and dextrously manipulate the position of the embellishments while minimizing inconvenient mess.

### SUMMARY OF THE INVENTION

The present invention is directed toward a device that is used to position beads, jewels, rhinestones, flatbacks, stickers and other small embellishments onto a particular medium such as jewelry, scrapbooks, containers or clothing. In use, it is preferred that two similar tools are used. Each tool comprises a shaft with adhesive material at one end and a plurality of prongs at the other end. The adhesive material of the first tool is used to removably secure an embellishment to that tool. Once the embellishment is secured on the first tool, the embellishment is positioned on the desired medium. To remove the embellishment from the first tool, pressure is applied on the embellishment by the plurality of prongs on the second tool. Once the embellishment is removed, the plurality of prongs on the second tool are used to precisely and conveniently position the embellishment on the desired medium. The use of the tools allows a user to precisely and cleanly position small embellishments on a particular medium without having any adhesive adhere to undesired locations or alter the design in an undesired fashion.

### BRIEF DESCRIPTION OF THE DRAWINGS

FIG. 1 is a perspective view of a preferred embodiment of the present invention;

FIG. 2 is perspective view of another embodiment of the present invention;

FIG. 3 shows a schematic representation of the invention in use; and

FIG. 4 shows a schematic representation of the invention in use.

### DESCRIPTION OF THE PREFERRED EMBODIMENTS

The present invention is directed to tools to position beads, jewels, rhinestones, flatbacks, stickers and other embellishments. The invention disclosed herein is, of course, susceptible of being embodied or conducted in many different manners. Shown in the drawings and described herein below in detail is a preferred embodiment of the invention. It is to be understood, however, that the present disclosure is an exemplification of the principles of the invention and does not limit the invention to the illustrated embodiment.

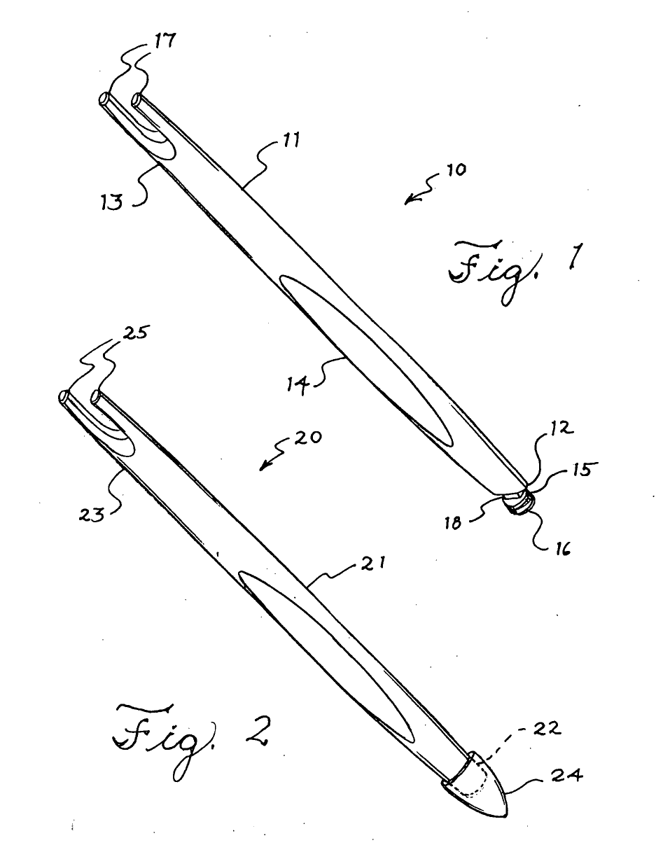

Referring to FIG. 1, in accordance with a preferred embodiment of the present invention, a perspective view of a positioning tool 10 is shown. Preferably the positioning tool 10 is constructed of plastic. The positioning tool 10 can also be constructed of other suitable materials known in the art, such as metal or wood. Body 11 of the positioning tool is a longitudinally elongated section. The body 11 has a generally circular cross-section and is an elongated cylindrical portion. In other embodiments, the cross-section of the body may be elliptical, square or rectangular without departing from the spirit of the invention. The body 11 may be hollow or solid. The body 11 has a proximal end 12 and a distal end 13. Also contained on the body 11 is an indention 14. As shown in FIG. 1, the indention 14 may have a flattened cross section. In another embodiment the entire body may have a flattened or widened cross section similar to the indention 14. The body 11 and/or the indention 14 may be textured.

Secured to the proximal end 12 of the body 11 is a stanchion 18. Connected to the stanchion 18 is a support member 15. In the preferred embodiment, the stanchion 18 and the support member 15 are integrally constructed with the body 11 and composed of the same material as the body 11.

Attached to the support member 15 is an adhesive 16. The adhesive 16 may be secured to the support member 15 by forming the adhesive 16 around or onto the support member 15. In another embodiment, the adhesive 16 may be secured to the body 11 by forming the adhesive 16 over the support member 15 and the stanchion 18 and onto the body 11.

In the preferred embodiment the adhesive 16 is a pressure sensitive adhesive such as florist wax or beeswax. The material of the adhesive 16 can be chosen from a number of natural or synthetic materials meeting certain characteristics lending suitability for use in picking up and positioning small decorative objects such as beads, rhinestones or stickers. The material must be durable enough for repeated use over many applications. The material should also be suitably tacky so as to be able to pickup an embellishment, yet be sufficiently non-adherent to permit release and separation of the embellishment from the adhesive 16 without undue force. It should be appreciated that the composition of the material of the adhesive 16 can be made of a number of materials as long as the desired characteristics are achieved.

Secured to the distal end 13 of the body 11 is a positioning fork 17. The positioning fork 17 is composed of a plurality of prongs or fingers. In the preferred embodiment, the positioning fork 17 is integrally constructed with the body 11 and composed of similar material. The positioning fork 17 has diametrically opposed prongs. In other embodiments, more than two prongs may be utilized. The plurality of prongs on the positioning fork 17 may be rounded, pointed or flat. By having a plurality of prongs, pressure can be applied at one or more points on the embellishment to securely hold it in position without slippage or lateral movement.

Referring to FIG. 2, a perspective view of a positioning tool 20 is shown. Preferably the positioning tool 20 is constructed of plastic. The positioning tool 20 can also be constructed of other suitable materials known in the art, such as metal or wood. Body 21 of the positioning tool 20 has a generally circular cross-section. In other embodiments, the cross-section of the body may be elliptical, square or rectangular without departing from the spirit of the invention. The body 21 may be hollow or solid. The body 21 has a proximal end 22 and a distal end 23. Although no indention is shown in the body 21, an indention similar to the one described in reference to FIG. 1 may be included. The body 21 may be textured.

The proximal end 22 of the body 21 may be closed or opened. Secured to the proximal end 22 of the body 21 is an adhesive 24. The adhesive 24 may be secured to the body 21 by forming the adhesive 24 around the body 21. The properties of the adhesive 24 are similar to those of described above in reference to the adhesive 16 of FIG. 1.

Secured to the distal end 23 of the body 21 is positioning fork 25. The positioning fork 25 is similar to the positioning fork 17 described above in reference to FIG. 1.

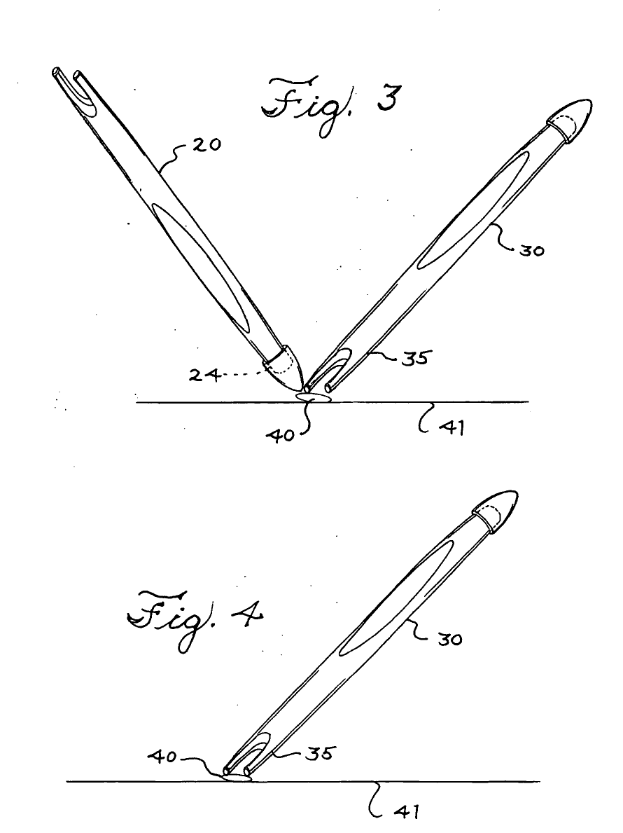

FIGS. 3-4 show the device in use. Two tools, the positioning tool 20 and the second positioning tool 30 are used. In the preferred embodiment, the positioning tool 20 and the second positioning tool 30 are identical. In other embodiments, the positioning tool 20 and the second positioning tool 30 are not identical. If the two tools are not identical, at least one tool must have an adhesive portion similar to the adhesive 24 and at least one of the other tools must have a positioning member similar to the positioning fork 35.

In operation, an embellishment 40 is removably secured to the adhesive 24 of positioning tool 20. Once the embellishment 40 is removably secured to the adhesive 24, the embellishment 40 is transferred to its desired location on the surface 41. The surface 41 is any location where the embellishment 40 is to be secured such as jewelry, a scrapbook, a container or clothing. Once the embellishment 40 is at its desired location, the positioning fork 35 of the second positioning tool 30 is used to remove the embellishment 40 from the adhesive 24. Once removed, the plurality of prongs on the positioning fork 35 are used to position the embellishment 40 into place. By using the plurality of prongs to remove and position the embellishment 40, the embellishment 40 is securely held in place by pressure applied through multiple points on the embellishment 40. Such pressure results in the embellishment 40 being less susceptible to undesirable movements such as jumping or dislodging movements that might cause it to move from the desired location on the surface 41.

Once the embellishment 40 is at the desired location on the surface 41, pressure is exerted on the embellishment 40 by plurality of prongs on the positioning fork 35. Such force secures the embellishment 40 onto the surface 41. Use of the plurality of prongs prevents any adhesive found on the surface 41 to stick to any undesirable location. It also prevents any undesirably interference with the design the embellishment 40 is used to create on the surface 41.

Preferred embodiments of this invention are described herein, including the best mode known to the inventors for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A bead positioning device comprising:
a first tool having a first support shaft including a first distal end and a first proximal end, a first positioning member attached to the first distal end and a first adhesive member attached to the first proximal end; and
wherein the first positioning member comprises a plurality of diametrically opposed prongs.

2. The bead positioning device of claim 1 wherein the first support shaft and the first positioning member are of integral construction.

3. The bead positioning device of claim 1 wherein the first support shaft is cylindrical

4. The bead positioning device of claim 3 wherein a portion of the first support shaft has a flat cross-section.

5. The bead positioning device of claim 1 wherein the entire first support shaft has a flat cross-section.

6. The bead positioning device of claim 1 wherein the first adhesive member further comprises a stanchion, a support member and an adhesive.

7. The bead positioning device of claim 1 wherein the first support shaft and the first positioning member are composed of material chosen from the group comprising: wood, plastic, metal and rubber.

8. The bead positioning device of claim 1 wherein the first adhesive member is composed of material chosen from the group comprising: natural adhesive and synthetic adhesive.

9. The bead positioning device of claim 1 wherein the first adhesive member comprises a pressure sensitive adhesive material.

10. The bead positioning device of claim 1 wherein the first support shaft and the first positioning member are rigid.

11. The bead positioning device of claim 1 wherein the first positioning member is flexible.

12. The bead positioning device of claim 1 wherein the prongs are rounded.

13. The bead positioning device of claim 1 wherein the prongs are pointed.

14. The bead positioning device of claim 1 wherein the first support shaft is textured.

15. The bead positioning device of claim 1 further comprising:
a second tool having a second support shaft including a second distal end and a second proximal end, a second positioning member attached to the second distal end and a second adhesive member attached to the second proximal end;
wherein the second positioning member comprises a plurality of diametrically opposed prongs; and
wherein the second adhesive member comprises a pressure responsive adhesive material.

16. A bead positioning device comprising:
a first tool having an attachment means for removably securing an object to the first tool and arranging the object on a surface;
a second tool having a positioning means for removing the object from the first tool;
wherein the positioning means has at least a set of “U-shaped” tines.
wherein the first tool and the second tool define elongated cylindrical portions;
wherein the first tool further comprises a flat cross-section; and
wherein the second tool further comprises a flat cross-section.

17. A method for arranging and positioning beading elements comprising the steps of:
providing a first support shaft;
providing an adhesive member attached to the first support shaft wherein the adhesive member comprises a pressure sensitive adhesive;
providing a second tool having a second support shaft;
providing a positioning member attached to the second support shaft wherein the positioning member further comprises a plurality of diametrically opposed prongs;
detachably securing an object to the adhesive member;
using the positioning member to remove the object from the adhesive member; and
using the positioning member to position the object against the surface.

18. The method of claim 15 further comprising the step of pressing the object against the surface.
